(19) United States
(12) Patent Application Publication
(10) Pub. No.: US 2007/0248568 A1
(43) Pub. Date: Oct. 25, 2007

(54) Aqueous wildlife attractant, cover scent, and browse supplement

(76) Inventors: Ralph Thompson, Creston, LA (US); Bobby Slaydon JR., Florein, LA (US); Kevin Slaydon, DeRidder, LA (US)

Correspondence Address: Williams Family Law Firm, L.L.C., P.O. Box 15, Natchitoches, LA, 71457, US

(21) Appl. No.: 11/407,565

(22) Filed: Apr. 19, 2006

(51) Int. Cl. A01N 25/00

(52) U.S. Cl. 424/84

(57) ABSTRACT

Wildlife enthusiasts and hunters use attractants to increase their chances of being in the presence of desirable wildlife at a designated location. Enthusiasts and hunters use cover scents to mask the human odor thereby helping to prevent scaring the desired wildlife from a designated location. Enthusiasts and hunters use browse supplements to aid the overall health and increase the viability of the natural wildlife population, especially the whitetail deer population. The present invention combines all of these characteristics to attract deer, cover the human scent, and supplement the browse diet of the deer with a high percentage carbohydrate solution that contains other essential nutrients and minerals to increase the overall health of the deer and the wildlife population in general.

### BACKGROUND

The present invention relates to wildlife attractants, more specifically aqueous whitetail deer attractants which are used by nature enthusiasts and hunters alike.

Whitetail deer hunting is a favorite pastime for many outdoorsmen and the need to attract wildlife to easily accessible designated hunting areas is a prime goal for these hunters. Large numbers of hunters spend significant resources, time and money, in their preparations for a hunting season and any advantage obtained over other hunters are closely guarded secrets that are many times more myth than fact.

Whitetail deer are elusive, wilily, naturally transient ruminant animals. Attractants are used to ensure the enthusiast and hunter will be able to bring the deer into close proximity and repeat this experience time and again.

Hunters use all manners of dispersing browse supplements, such as corn dispersed by mechanical storage devices and various grass plots are seeded and nurtured to coincide with the beginning of the hunting season. One of the main reasons for supplementing the natural browse is to ensure that the local whitetail population will have sufficient food sources in a particular area to avoid the population from migrating out of the hunter's designated hunting area.

Whitetail hunters who are successful in their endeavors always strive to improve the quality of the trophy they take from the wild. Browse supplements allow a hunter to supplement the natural and supplied feed sources and many times improve the quality of the feed that the deer are naturally foraging. The improved quality of the feed can lead to an increased weight and height of the deer which are coveted categories used to compare trophy deer.

A main concern for the average and trophy hunter is the quality of the deer's antlers and browse supplements, with the proper nutrient and carbohydrate mix, can help ensure a healthy animal that will reach its full potential, in height, weight and antler size.

A problem that plagues all hunters and wildlife enthusiasts is that deer have a keen sense of smell and the hunter or enthusiast, no matter how careful, will emit a scent that can be detected by a deer causing the animal to bolt away or never come into view in the first place. Cover scents have been developed that aide the hunter or enthusiast mask or eliminate this problem to increase their chances of being in the presence of the object of the obsession, the whitetail deer.

For many individuals, they are not just focused on the upcoming hunting season, but are interested in the management of the local deer population as a whole. Population management is key to ensure that success is obtained over the years and not for a single season.

Aqueous wildlife attractants and cover scents, both separate and in combination, and are well known in the prior art. An aqueous form is desirable as the liquid is easily stored and applied from any manner of squeeze bottle or dropper readily commercially available. The wildlife attractant and cover scent, singularly or in combination, is typically composed of portions that the deer finds palatable and a strong scent that covers the smell of the hunter or enthusiast. These attractants and/or cover scents, some made from synthetic materials or natural, do not address the need to ensure the health of a wildlife population by providing a stable source of browse supplement that will provide a proper nutrient mix that will aide the growth of the population and improve the quality of population, such as U.S. Pat. No. 6,153,230 to Corley. Other attractants and/or cover scents are made from substances that make for a pungent and unpleasant odor such as the semi-solid gelatin mix of diluted portion of deer urine and rice bran as in U.S. Pat. No. 5,916,552 to Perry and U.S. Pat. No. 5,369,903 to Cox comprised in part of urine from domestic goats. These attractants and/or cover scents are from animal sources that require large numbers of domesticated animals from which to collect the urine, some recommend the preferred urine come from only the female animal, and these large herds are not economically feasible and are labor intensive.

Browse supplements are available for ruminant animals to aide in the growth of the ruminant and are well known in the prior art, such as U.S. Pat. No. 5,252,346 to Krause. These ruminant browse supplements are mainly used to aide the growth and health of farm animals and are not appropriate to use as a wildlife attractant and/or cover scent. Many are used to aide in the prevention of certain ruminant diseases, such as grass tetany in cattle as seen in U.S. Pat. No. 3,794,740 to Achorn et al.

Thus, there is a need for an aqueous wildlife attractant, cover scent and browse supplement combination that allows a wildlife enthusiast or hunter to repeatedly and reliably bring wildlife to a desired area, cover the scent of the human to prevent scaring the wildlife away from the desired area, and supplement the natural feed to ensure a healthy population and improve the weight, height and antler size of the deer which are prized characteristics among deer hunters that is obtained from available sources not requiring a large animal herd and that is easily applied to natural and supplemental feed sources as well as various scent distribution sources.

### SUMMARY

The present invention meets this need by providing a wildlife attractant, cover scent, and browse supplement that allows for the repeated and reliable return of wildlife to a desired area, covers the scent of the nature enthusiast or hunter without use of pungent odor sources, and provides a supplemental source of essential minerals, comprising of ferrous sulfate, sodium chloride, and calcium carbonate, and carbohydrates that helps ensure wildlife population stability and increased viability.

In another aspect of this invention is a process for preparing a composition for use as a wildlife attractant, cover scent, and browse supplement is provided. The process comprises (a) heating a mixture in water which contains at least a portion of granulated sugar; (b) adding sodium chloride and heating the mixture to ensure suspension of the components; (c) adding vanilla extract and heating the mixture to ensure suspension of the components; (d) cooling the aqueous solution; (e) adding liquid ferrous sulfate to the solution and mixing the solution to ensure suspension of the components without precipitation; (f) agitating the solution for a period of time to ensure no precipitation; and (g) adding calcium carbonate and heating the aqueous solution to ensure suspension of the components without precipitant present in the final form.

### DESCRIPTION

A preferred embodiment of the present invention would result in a product of greater than fifty percent carbohydrate. It is preferred that the solution contain a maximum of two percent sodium chloride and a minimum of two percent of both calcium carbonate and ferrous sulfate. It is preferred that the ratio of one to one of ferrous sulfate to calcium carbonate. It is preferred that the water used to suspend the components in solution be deionized water. It is preferred that the carbohydrate source be sucrose or common granulated table sugar. It is preferred that the heating of the solution be great enough to destroy most microbial contamination and stored in sterile containers. It is preferred that the mixing of solution be by vortexing for at least one minute to ensure suspension of the components in solution when components are added and the agitation of the solution be done by electronic rocker for fifteen minutes to aid in the proper suspension of the components. It is preferred that no precipitate be present in the final form of the present invention.

It is preferred that the present invention be applied to a given location to ensure the attraction of the wildlife to that location. It is preferred that the present invention be applied directly to objects that carry the scent of the wildlife enthusiast or hunter, such as boots, clothes, equipment, blinds or tree stands; the present invention can also be placed in any type of scent dispenser from canisters, droppers, scent drag rags, or the like. It is preferred that the present invention be applied directly to feed sources such as corn that has been or is to be spread by hand or by mechanical dispenser, food plots, mineral licks, or the like.

Although the present invention has been described in considerable detail with reference to certain preferred versions thereof, other versions are possible. Therefore, the spirit and scope of the appended claims should not necessarily be limited to the description of the preferred versions contained herein.

What is claimed is:

1. A composition which is formed from ingredients comprising:
a) a solution formed from a mixture of at least a portion of sodium chloride and a portion of carbohydrate;
b) vanilla extract;
c) ferrous sulfate; and
d) calcium carbonate.

2. The composition of claim 1 where the solution comprises at least fifty percent carbohydrate.

3. The composition of claim 2 where the solution contains a ratio of one to one ferrous sulfate to calcium carbonate.

4. The composition of claim 3 where the ferrous sulfate added to the solution is liquid ferrous sulfate.

5. The composition of claim 4 wherein the ingredients further comprise deionized water.

6. The composition of claim 5 wherein the carbohydrate added to the solution is sucrose.

7. A method of attracting wildlife to a given location which method comprises applying a composition of claim 1 to the given location.

8. A method of attracting wildlife to a given location which method comprises applying a composition of claim 6 to the given location.

9. A method of covering the scent of an object which method comprises applying a composition of claim 1 to the object.

10. A method of covering the scent of an object which method comprises applying a composition of claim 6 to the object.

11. A method of supplementing the browse feed source(s) of wildlife which method comprises applying a composition of claim 1 to the feed source(s).

12. A method of supplementing the browse feed source(s) of wildlife which method comprises applying a composition of claim 6 to the feed source(s).

13. A process for preparing a composition for use as a wildlife attractant and/or cover scent and/or browse supplement, the process comprising:
a) heating a mixture of comprising water and carbohydrate, to form a solution;
b) adding sodium chloride to the solution and heating the solution;
c) adding vanilla extract and heating the solution;
d) cooling the solution and ensuring no precipitate forms;
e) adding ferrous sulfate to the solution and vortexing the solution;
f) mixing the solution by placing the solution on an electronic rocker and ensuring no precipitate forms;
g) adding calcium carbonate to the solution and heating the solution;
h) cooling the solution and ensuring no precipitate forms; and
i) storing the solution in sterile containers.

14. A process according to claim 13 wherein the solution comprises at least fifty percent carbohydrate.

15. A process according to claim 13 wherein the solution contains a ratio of one to one ferrous sulfate to calcium carbonate.

16. A process according to claim 13 wherein the ferrous sulfate added to the solution is liquid ferrous sulfate.

17. A process according to claim 13 wherein the ingredients further comprise deionized water.

18. A process according to claim 13 wherein the carbohydrate added to the solution is sucrose.
